(19) United States
(12) Patent Application Publication
(10) Pub. No.: US 2026/0108972 A1
(43) Pub. Date: Apr. 23, 2026

(54) Systems and Methods for Dual Plasma Wire Arc Additive Manufacturing

(71) Applicant: Relativity Space, Inc., Long Beach, CA (US)

(72) Inventors: Justin Gray, Long Beach, CA (US); Fritz C. Gruber, Long Beach, CA (US); Jenna Johns, Long Beach, CA (US); Jeremy Krol, Long Beach, CA (US)

(73) Assignee: Relativity Space, Inc., Long Beach, CA (US)

(21) Appl. No.: 19/362,168

(22) Filed: Oct. 17, 2025

Related U.S. Application Data
(60) Provisional application No. 63/709,223, filed on Oct. 18, 2024.

(51) Int. Cl. B23K 9/16; B23K 9/04; B23K 9/29; B23K 10/02; B33Y 10/00

(52) U.S. Cl. CPC B23K 9/164; B23K 9/04; B23K 9/296; B23K 10/027; B33Y 10/00

(57) ABSTRACT

A torch assembly for additive manufacturing is described. The torch assembly can apply at least two arcs surrounding a feed wire during an additive manufacturing process. The additional arc provides better shielding functions during the process.

### CROSS-REFERENCE TO RELATED APPLICATIONS

The current application claims the benefit of and priority under 35 U.S.C. § 119 (e) to U.S. Provisional Patent Application No. 63/709,223 entitled “Systems and Methods for Dual Plasma Wire Arc Additive Manufacturing” filed Oct. 18, 2024. The disclosure of U.S. Provisional Patent Application No. 63/709,223 is hereby incorporated by reference in its entirety for all purposes.

### FIELD OF THE INVENTION

This disclosure generally refers to systems and methods for dual plasma wire arc additive manufacturing.

### BACKGROUND

Additive manufacturing is a process by which a product or part is manufactured by adding one layer of material on top of another in a sequence or pattern that would result in a solid part being built. This method of manufacturing is commonly referred to as three dimensional or 3D printing and can be done with different materials, including plastic and metal. Wire arc additive manufacturing (WAAM) is a production process used to 3D print and/or repair metal parts using a metal wire feedstock and an electric arc as an energy source.

### SUMMARY OF THE INVENTION

Systems and methods in accordance with some embodiments of the invention are directed to dual plasma systems and dual plasma WAAM processes.

Some embodiments include a torch assembly, comprising: an inner gas channel configured to flow an inner shielding gas through a gas mixing region within the torch assembly; a middle gas channel concentric with the inner gas channel and configured to flow a middle shielding gas through the gas mixing region; an outer gas channel concentric with the middle gas channel and configured to flow an outer shielding gas around the gas mixing region, wherein the outer shielding gas does not mix with the inner shielding gas or the middle shielding gas within the torch assembly; a nonconsumable electrode configured to flow a second current through a mixture of the inner shielding gas and the middle shielding gas in the gas mixing region, wherein the second current ionizes the mixture to form a plasma; and a consumable electrode feeder configured to flow a first current through a consumable electrode, and further configured to feed the consumable electrode through the plasma in the gas mixing region, wherein the consumable electrode, the plasma, and the outer shielding gas all exit the torch assembly substantially concentrically.

In some embodiments, the torch assembly further comprises a gas diffuser located within the outer gas channel.

In some embodiments, the consumable electrode feeder includes a metal inert gas (MIG) torch.

In some embodiments, the nonconsumable electrode is a tungsten electrode.

In some embodiments, the torch assembly further comprises a first power supply and a second power supply.

Some embodiments include method comprising: feeding a feed wire through a main channel of a torch assembly, wherein a distal end of the feed wire is in proximity to a substrate; supplying an inner shielding gas along the feed wire; supplying a middle shielding gas, wherein the inner shielding gas mixes with the middle shielding gas near a distal end of the main channel; applying a second electrical current through an electrode disposed at the distal end of the main channel to the distal end of the feed wire such that the second electrical current is configured to start an arc that is configured to ionize a mixture of the inner shielding gas and the middle shielding gas to form a plasma arc surrounding the feed wire; retracting the feed wire away from the distal end of the main channel; and applying a first electrical current through the feed wire, wherein the first electrical current is configured to create an electric arc to melt the feed wire to be deposited onto the substrate.

In some embodiments, the electrode is positioned inside the torch assembly.

In some embodiments, the electric arc is configured to ionize the inner shielding gas to form a shielding gas arc, wherein the shielding gas arc is positioned within the plasma arc.

In some embodiments, the plasma arc and the shielding gas arc surround a molten feed wire annually when the molten feed wire is deposited onto the substrate.

In some embodiments, the method further comprises reducing a velocity of supplying the inner shielding gas along the feed wire when applying the second electrical current through the feed wire.

In some embodiments, the method further comprises applying a third electrical current through the electrode when retracting the feed wire, wherein the third electrical current is greater than the first electrical current.

In some embodiments, the method further comprises supplying an outer shielding gas surrounding the feed wire, wherein the outer shielding gas is not ionized.

In some embodiments, the method further comprises maintaining the plasma arc while retracting the feed wire.

In some embodiments, the middle shielding gas has a laminar flow profile.

Some embodiments include a method comprising: supplying an inner shielding gas along a feed wire, wherein the feed wire is fed through a main channel of a torch assembly; supplying a middle shielding gas, wherein the inner shielding gas mixes with the middle shielding gas near a distal end of the main channel; positioning a distal end of the feed wire in contact with a substrate; retracting the feed wire away from the substrate; applying a second electrical current through an electrode disposed at the distal end of the main channel to the distal end of the feed wire, wherein the second electrical current is configured to ignite an arc; determining if the arc is ignited: if not ignited, repeating the positioning, retracting, applying the second electrical current, and determining steps until the arc is ignited; wherein the arc is configured to ionize a mixture of the inner shielding gas and the middle shielding gas to form a plasma arc surrounding the feed wire; and applying a first electrical current through the feed wire, wherein the first electrical current is configured to create an electric arc to melt the feed wire to be deposited onto the substrate.

In some embodiments, the electrode is positioned inside the torch assembly.

In some embodiments, the electric arc is configured to ionize the inner shielding gas to form a shielding gas arc, wherein the shielding gas arc is positioned within the plasma arc.

In some embodiments, the method further comprises applying a third electrical current through the electrode when retracting the feed wire, wherein the third electrical current is greater than the first electrical current.

In some embodiments, the method further comprises supplying an outer shielding gas surrounding the feed wire, wherein the outer shielding gas is not ionized.

In some embodiments, the method further comprises maintaining the plasma arc while retracting the feed wire.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIG. 1A illustrates a profile view of an additive manufacturing applicator in accordance with an embodiment.

FIG. 1B illustrates a cross-section view of the additive manufacturing applicator in accordance with an embodiment.

FIG. 1C illustrates a front view of an additive manufacturing applicator in accordance with an embodiment.

FIG. 1D illustrates a cross-section view of the additive manufacturing applicator in accordance with an embodiment.

FIG. 2A illustrates a front view of a dual plasma torch assembly in accordance with an embodiment.

FIGS. 2B and 2C illustrate cross-section views of the dual plasma torch assembly in accordance with embodiments.

FIG. 2D illustrates an enlarged view of the distal end of the dual plasma torch assembly in accordance with an embodiment.

FIG. 2E illustrates a top view of a dual plasma torch assembly in accordance with an embodiment.

FIG. 2F illustrates a top view of a dual plasma torch assembly without the MIG torch in accordance with an embodiment.

FIG. 2G illustrates a top view of a dual plasma torch assembly without the spatter guard, the ceramic insert, and the inner cup in accordance with an embodiment.

FIG. 2H illustrates a top view of a dual plasma torch assembly in accordance with an embodiment.

FIG. 2I illustrates a bottom view of a dual plasma torch assembly in accordance with an embodiment.

FIG. 3 illustrates a flow chart of starting a dual plasma process in accordance with an embodiment.

FIG. 4 illustrates a flow chart of starting a dual plasma process in accordance with an embodiment.

### DETAILED DESCRIPTION OF THE INVENTION

It will be understood that the components of the embodiments as generally described herein and illustrated in the drawings may be arranged and designed in different configurations. Thus, the following description of various embodiments, as represented in the drawings, is not intended to limit the scope of the disclosure but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that a feature or advantage that may be only realized with a single embodiment of the present invention. These features and/or advantages may be or are in another embodiment of the invention.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment. Thus, the phrases “in one embodiment”, “in an embodiment”, and similar language throughout this specification may, but do not necessarily, all refer to the same embodiment.

### Dual Plasma Wire Arc Additive Manufacturing

WAAM 3D printing of metallic structures typically involves using an energy source to create a weld pool, and feeding a metal feed wire into the weld pool by way of a printing head. Energy is used to create the weld pool. WAAM systems typically pass an electric current through the feed wire into the weld pool. The printing head and subsequently the weld pool can move. As the printing head and the welding pool move, the trailing edge of the pool cools and solidifies. This process of gradually moving the printing head along a path can lead to a printed part.

Additive arc welding processes, where feed wire is deposited to a surface or substrate, can be influenced and aided by the use of a shielding gas surrounding the feed wire and weld pool. The shielding gas can be ionized by an electric arc formed between the feed wire and the printed part to form a plasma. The shielding gas can help to make a better weld pool for an overall better part. The shielding gas can protect the weld pool from corrosive or contaminating gases and moisture.

In several embodiments, an additive manufacturing applicator can be configured to achieve improvements to deposition rates and/or quality in WAAM processes. In some embodiments, the applicator can include a dual plasma torch assembly. The torch assembly can incorporate at least one metal inert gas (MIG) torch and at least one tungsten electrode. As discussed in greater detail below, embodiments of the dual plasma torch assembly and its associated dual plasma processes combine MIG welding and plasma arc welding.

The dual plasma torch assembly can feed a feed wire through the MIG torch. A MIG torch can be referred to as a consumable electrode feeder and the feed wire can be referred to as a consumable electrode. The feed wire can be melted by an arc (such as an electric arc) at a distal end of the MIG torch. The melted feed wire can be deposited on a substrate in a layer-by-layer fashion such that a part can be formed using the feed wire. A voltage is applied between the feed wire and the substrate such that the arc can be generated to melt the feed wire. In various embodiments, a voltage is applied between the tungsten electrode and the substrate via the feed wire to ignite a plasma arc. The tungsten electrode can be referred to as a nonconsumable electrode. In other words, the feed wire is used to conduct the current between the tungsten electrode and the substrate to establish the plasma arc. After ignition, the plasma arc can exist independent of the feed wire and/or the MIG arc. The plasma arc can provide additional shielding to the feed wire and/or the part during printing. Using a tungsten electrode in a wire arc additive manufacturing applicator can be advantageous to improve output quality (e.g., grain structure), and to improve deposition rates.

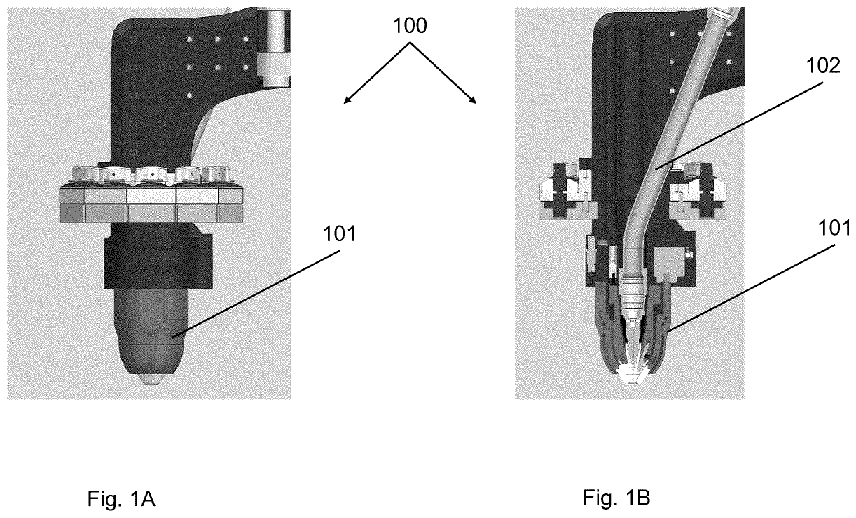

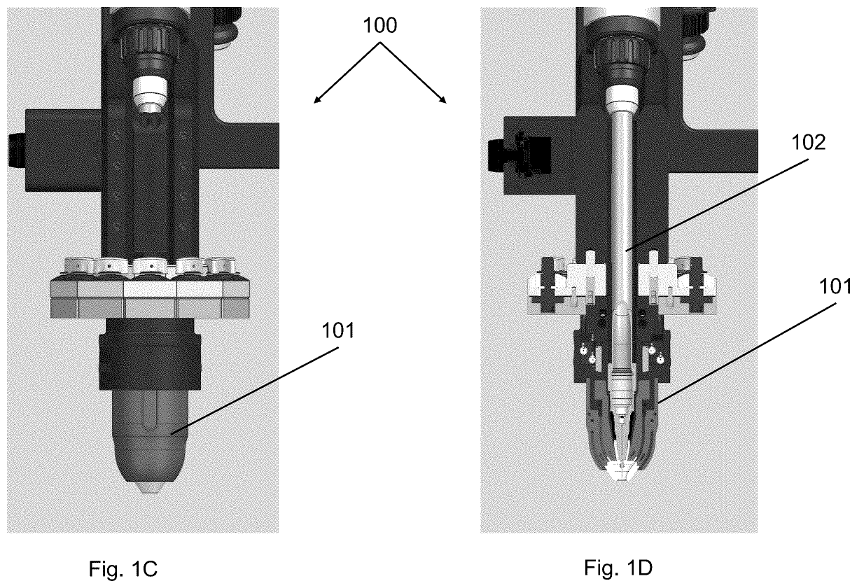

FIG. 1A illustrates a profile view of an additive manufacturing applicator 100 in accordance with an embodiment. FIG. 1B illustrates a cross-section view of the additive manufacturing applicator 100 shown in FIG. 1A in accordance with an embodiment. FIG. 1C illustrates a front view of an additive manufacturing applicator 100 in accordance with an embodiment. FIG. 1D illustrates a cross-section view of the additive manufacturing applicator 100 shown in FIG. 1C in accordance with an embodiment.

The additive manufacturing applicator 100 can include a dual plasma torch assembly 101. The torch assembly 101 can incorporate a MIG torch 102 inside. The MIG torch 102 can be referred to as a consumable electrode feeder. The distal end of the MIG torch 102 is positioned concentrically with the distal end of the torch assembly 101.

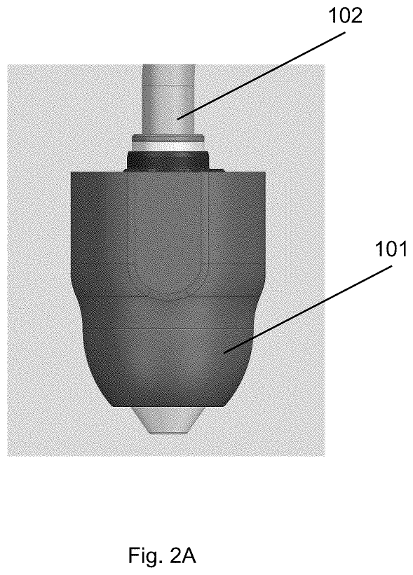

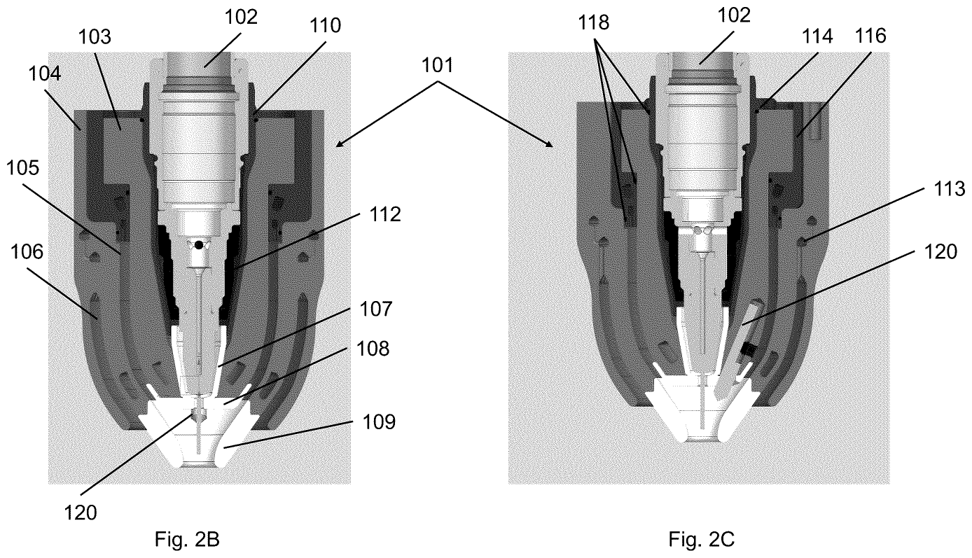

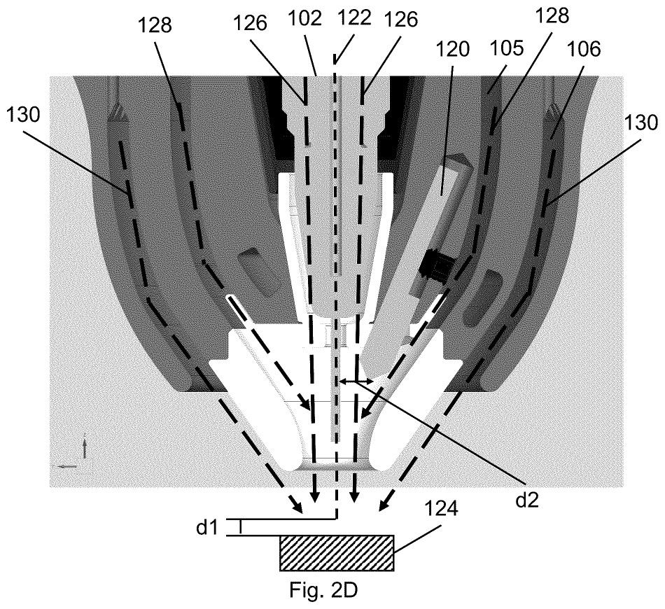

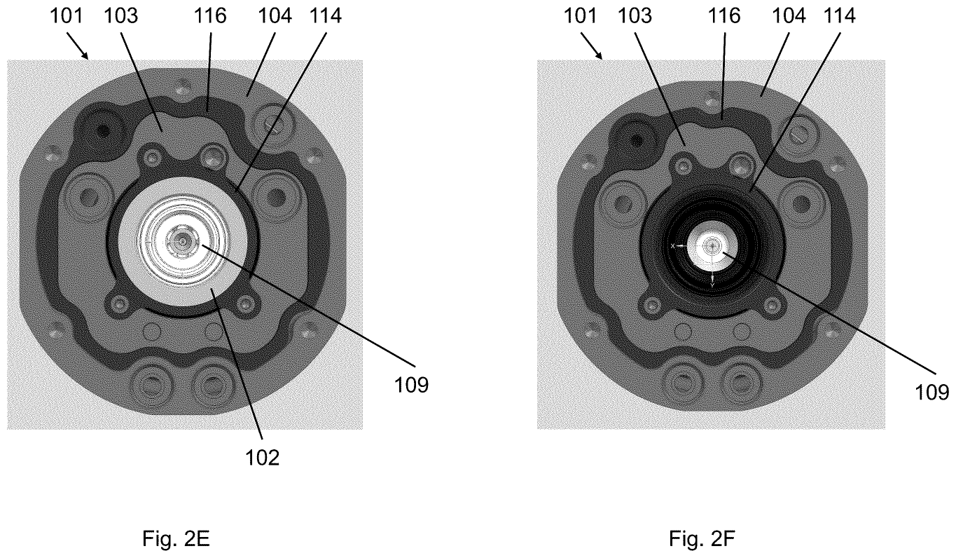

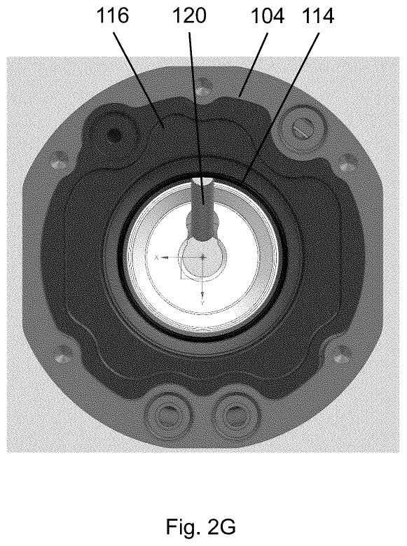

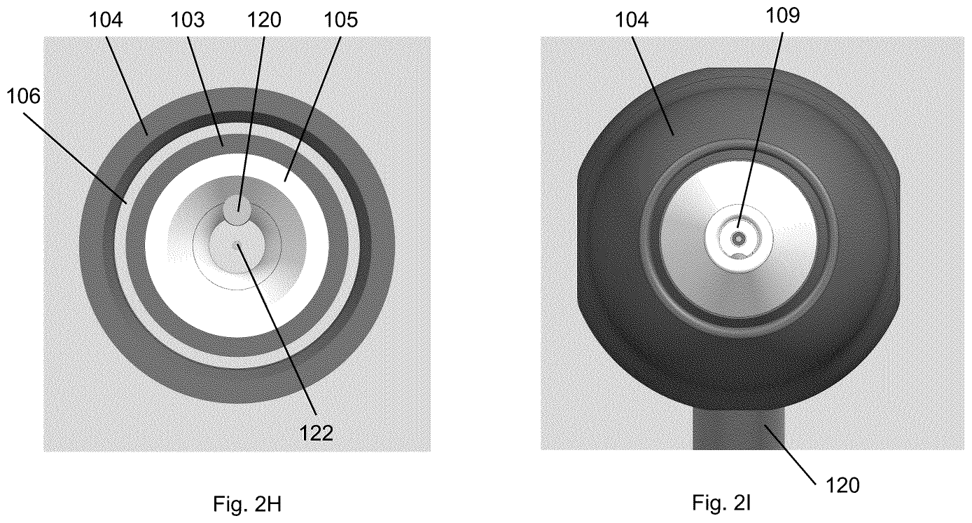

FIG. 2A illustrates a front view of a dual plasma torch assembly 101 in accordance with an embodiment. FIG. 2B illustrates a cross-section view of the dual plasma torch assembly 101 shown in FIG. 2A in accordance with an embodiment. FIG. 2C illustrates a different cross-section view, rotated through a quarter-turn, of the dual plasma torch assembly 101 shown in FIG. 2A in accordance with an embodiment. FIG. 2D illustrates an enlarged view of the distal end of the dual plasma torch assembly 101 shown in FIG. 2A in accordance with an embodiment.

FIG. 2E illustrates a top view of a dual plasma torch assembly 101 shown in FIG. 2A in accordance with an embodiment. FIG. 2F illustrates a top view of a dual plasma torch assembly 101 without the MIG torch 102 shown in FIG. 2E in accordance with an embodiment. FIG. 2G illustrates a top view of a dual plasma torch assembly 101 without the spatter guard 112, the ceramic insert (107, 108, and 109), and the inner cup 103 shown in FIG. 2F in accordance with an embodiment. FIG. 2H illustrates a top view of a dual plasma torch assembly 101 shown in FIG. 2A in accordance with an embodiment. FIG. 2I illustrates a bottom view of a dual plasma torch assembly 101 shown in FIG. 2A in accordance with an embodiment.

The torch assembly 101 can include a 2-cup nozzle. The inner cup 103 and the outer cup 104 are positioned concentrically. The inner cup 103 forms a main channel 110. The MIG torch 102 is positioned inside the main channel 110. The MIG torch 102 can be a commercially available MIG torch or any type of torch or welding torch that can perform metal inert gas welding. The inner cup 103 and the outer cup 104 can each have a circular exit, where the circular exit of the inner cup 103 is located concentrically inside the circular exit of the outer cup 104. The feed wire 122 of the MIG torch 102 can be directed through the circular exit of the inner cup 103. The feed wire 122 can be referred to as a consumable electrode. A first flow channel 105 is formed between the inner cup 103 and the outer cup 104. A second flow channel 106 is formed within the outer cup 104. Diffusers 113 can be inserted or as a built-in part in the second channel 106 to change velocity internally before exiting the second channel 106 and/or to evenly distribute the flow. In some embodiments, the flow velocity can be controlled by input gas flow and the cross-sectional area of the channel (110, 105, and/or 106) at the exit. In yet other embodiments, the torch assembly 101 can include a 1-cup nozzle in which parts 103, 104, and 116 are comprised of a single piece, whether all plastic or all another material, so that channel 105 passes through the single piece in a fashion similar to how channel 106 passes through part 104 in the depicted embodiments. In such other embodiments, some or all of O rings 118 may be omitted. The nozzle (1-cup or 2-cup) can be additively manufactured (such as using powder based additive manufacturing methods, such as powder bed fusion 3D printing). The sizes and dimensions of the nozzle can be optimized to achieve the desired channel sizes and/or flow profiles. The nozzle can be made with various types of materials including (but not limited to) metals, metal alloys, copper, and copper alloy. As can be readily appreciated, the nozzle can be made with any suitable material with a desired melting temperature. In some embodiments, the nozzle materials do not need to have a higher melting temperature than the feed wire material. In some embodiments, the nozzle includes water cooling channels to cool the nozzle.

The torch assembly 101 can have a first part 107, a second part 108, and a third part 109 which collectively have a central through-hole, and which may be threaded for insertion and removal. The first part 107 and the second part 108 can thread together where the inner cup 103 is sandwiched between the first part 107 and the second part 108. The second part 108 can have a flat bottom facing a cavity at the end of first flow channel 105. In some embodiments, the second part 108 does not have a flat bottom. The shape of the bottom may affect gas flow from the first flow channel 105. The third part 109 can protrude further towards a deposition site than the circular exits of the inner cup 103 and the outer cup 104. In several embodiments, the third part 109 can be the closest part (e.g., not considering the feed wire) of the torch assembly 101 to the part and/or deposition site. The feed wire 122 can pass through the insert. The shape and/or geometry of first part 107, second part 108, and third part 109 can be optimized to achieve the desired gas flow from the torch assembly and/or change the geometry of the distal end of the torch assembly. First part 107, second part 108, and third part 109 can make cleaning the torch assembly easier by simply swapping them out, can be manufactured using methods such as (but not limited to) machining, can be formed of ceramic, can be made of a material that is non-wetting with the liquid (e.g., melted) form of the feed wire, can be made of a non-wetting material such as (but not limited to) ceramics, alumina, boron nitride, glass, borosilicate, soda lime glass, dielectric polymers, fluorinated polymers, and/or polytetrafluoroethylene, and can have electrical insulating properties.

The MIG torch 102 can be wrapped around by a spatter guard 112. Gas diffusers 114 and 116 can be positioned inside the main channel 110 and the first channel 105 respectively towards the proximal end of the torch assembly 101. The gas diffusers 114 and 116 can be additively manufactured (such as using powder based additive manufacturing methods, such as powder bed fusion 3D printing). The gas diffusers 114 and 116 can be made of various types of materials including (but not limited to) polymers and/or plastics. A plurality of O-rings 118 can be used to form the desired seal between the gas diffusers and the 2-cup nozzle.

A tungsten electrode 120 can be incorporated in the 2-cup nozzle. The tungsten electrode 120 can be referred to as a nonconsumable electrode. The distal end of the tungsten electrode 120 protrudes through the second part 108 into the cavity at the end of first flow channel 105. The tungsten electrode 120 can be a commercially available electrode or any type of electrode that can perform tungsten inert gas welding.

In many embodiments, the dual plasma torch assembly 101 has two power supplies: a second power supply for the tungsten electrode 120 and a first power supply for the MIG torch 102. One or both of the power supplies may include a continuity tester that aids in establishment of a dual plasma as discussed below. To establish the dual plasma, many embodiments first establish a plasma arc using the tungsten electrode 120. Following the establishment of the plasma arc, several embodiments start the MIG torch 102 to establish the MIG arc.

Turning to FIG. 2D, several starting sequences for a dual plasma torch assembly 101 are described. A feed wire 122 can be fed through the MIG torch 102 located in the main channel 110 of the torch assembly 101 to be near or in contact with a print substrate 124. The print substrate 124 is a substrate upon which to deposit a molten feed wire. The print substrate 124 can be a substrate for a print part or a surface of a print part. An inner shielding gas 126 can flow through the MIG torch 102 surrounding the feed wire 122. A middle shielding gas 128 can flow through the first flow channel 105. The inner shielding gas 126 and the middle shielding gas 128 are mixed in the cavity near the distal end of the first flow channel 105. An outer shielding gas 130 can flow through the second flow channel 106. The shielding gas (126, 128, and/or 130) can be any type of inert gas or non-reactive welding gas including (but not limited to) argon, carbon dioxide, nitrogen, helium, neon, krypton, xenon, radon, and any combinations thereof. In some embodiments, the inner shielding gas 126, the middle shielding gas 128, and the outer shielding gas 130 can be the same type of gas. In some embodiments, at least one of the inner shielding gas 126, the middle shielding gas 128, and the outer shielding gas 130 is a different type of gas than the other(s).

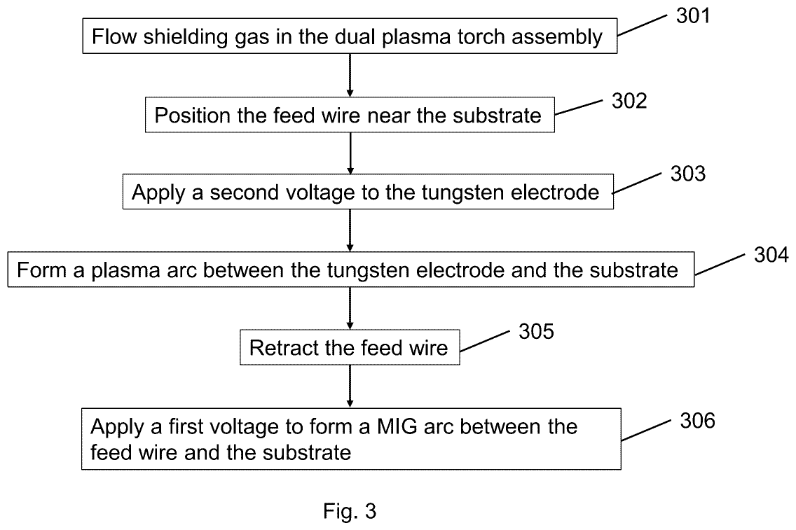

In several embodiments, described here and in the context of FIG. 3 below, to start the dual plasma process the feed wire 122 is positioned near the print substrate 124. There is a distance d1 between the distal end of the feed wire 122 and the print substrate 124. In several embodiments, the distance d1 is optimized to enable an effective and consistent ignition of the plasma arc. If the distance is less than the optimal d1, the tungsten electrode 120 may not be able to start the plasma arc. If the distance is greater than the optimal d1, the voltage applied to the tungsten electrode 120 may not be able to jump from the electrode 120 to the feed wire 122. In certain embodiments, d1 can be about 500 μm. In certain embodiments, d1 can be about 1 mm. In certain embodiments, d1 can be about 2 mm. In certain embodiments, d1 can be about 3 mm. In certain embodiments, d1 can be about 4 mm. In certain embodiments, d1 can be about 5 mm. In certain embodiments, d1 can be about 6 mm.

A second voltage (or current) can be applied to the tungsten electrode 120. The applied voltage can create an arc (not shown) between the distal end of the tungsten electrode 120 and the substrate 124 using the conductive path of the feed wire 122. In other words, the tungsten electrode 120 is in close proximity to the feed wire 122 such that an arc can be established from the tungsten electrode 120 across the feed wire 122 to the substrate 124. The arc can ionize the mixed inner shielding gas 126 and middle shielding gas 128 to form the plasma arc. The distance d2 between the distal end of the tungsten electrode 120 and the feed wire 122 is optimized to enable an effective ignition of the plasma arc. In certain embodiments, d2 can be less than or equal to about 500 μm. In certain embodiments, d2 can be less than or equal to about 1 mm. In certain embodiments, d2 can be less than or equal to about 2 mm. In certain embodiments, d2 can be less than or equal to about 3 mm. In certain embodiments, d2 can be less than or equal to about 4 mm. In certain embodiments, d2 can be less than or equal to about 5 mm. As can be readily appreciated, d2 may vary when different sizes of feed wire and/or different power input (applied voltage and/or current) are used in the torch assembly.

In several embodiments, a DC power supply can be used to supply the voltage (or current) to ignite the plasma arc. In some embodiments, the current flows from the tungsten electrode 120 to the substrate 124. In some embodiments, the current flows from the part 124 to the tungsten electrode 120. The direction of the current flow depends on the polarity of the DC power supply. The ignition of the plasma arc occurs as described above regardless of the flow direction of the current.

After the ignition of the plasma arc, the feed wire 122 can be retracted almost instantly. While the feed wire 122 is retracted, the plasma arc between the distal end of the tungsten electrode 120 and the substrate 124 remains. The plasma arc may be established in at least two ways. In some embodiments, the plasma arc may be able to directly jump from the distal end of the tungsten electrode 120 to the substrate 124 running along the feed wire 122. In other embodiments, a first arc may be created between the substrate 124 and the distal end of the feed wire 122, while the applied power runs through the wire (no arc) and creates a second arc between the feed wire 122 and the distal end of the tungsten electrode 120. When the wire is retracted, it pulls the first arc up until the two arcs merge such that the distal end of the tungsten electrode 120 is able to arc directly to the substrate 124. If the feed wire 122 is not retracted after the ignition of the plasma arc, the plasma arc may collapse because of too much current running into the feed wire, such that the feed wire degrades or melts off.

When igniting the plasma arc, the power (voltage or current) applied to the tungsten electrode 120 is kept as low as possible to be able to start the arc while not melting or degrading the feed wire 122. Meanwhile, the shielding gas (the inner shielding gas 126, the middle shielding gas 128, and the outer shielding gas 130) can cool the feed wire 122. Once the inner shielding gas 126 and the middle shielding gas 128 are ionized, they will not be able to cool the feed wire 122. Thus, the feed wire 122 needs to be retracted after the ignition of the plasma arc in order to maintain the plasma arc and the integrity of the feed wire.

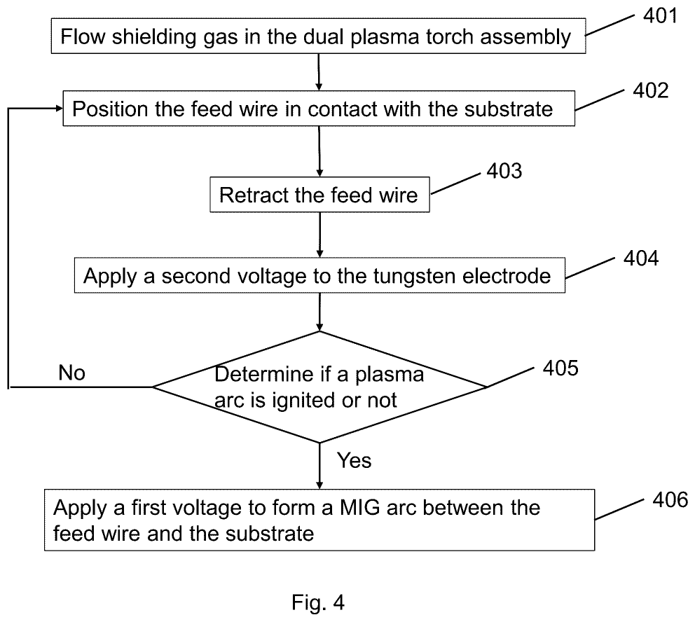

In several embodiments, described here and in the context of FIG. 4 below, to start the dual plasma process the feed wire 122 is positioned in contact with the print substrate 124. As such, in these embodiments, the feed wire 122 is initially nearer to the print substrate than the distance d1. Feed wire 122 can be positioned in contact by extending it from MIG torch 102 until a continuity tester, such as one included in the first power supply for the MIG torch 102, reports continuity has been achieved.

A second voltage (or current) can be applied to the tungsten electrode 120 by the second power supply. The applied voltage may or may not create an arc (not shown) between the distal end of the tungsten electrode 120 and the substrate 124 using the conductive path of the feed wire 122. In other words, the tungsten electrode 120 is in close proximity to the feed wire 122 such that an arc can be established from the tungsten electrode 120 across the feed wire 122 to the substrate 124, although this establishment may not succeed during a first attempt. During the process of establishing the arc, the feed wire 122 can be repeatedly tapped upon and retracted away from the substrate 124 back into MIG torch 102 at a given rate. During each tap-retraction cycle, the feed wire 122 can be retracted from the substrate 124 to a distance at d1 or greater than d1. During, or at the end of, each tap-retraction cycle, an ignition determination can be made. For example, the second power supply for the tungsten electrode 120 can self-determine that it is not consuming enough power to support an ignited plasma arc. If ignition of the arc is not successful, the dual plasma process can restart by repositioning the feed wire 122 in contact with the substrate 124 and repeating the tapping and retraction processes until ignition happens. Restarts can occur indefinitely until ignition is successful. Once the arc is ignited, the tapping process stops.

When the arc is ignited, the feed wire 122 may already have moved away from the substrate 124 at a distance d1 or even greater than d1. In some embodiments, when the arc is ignited the feed wire 122 is already retracted away from the substrate 124 as part of the tapping process. In other embodiments, when the arc is ignited the feed wire 122 is still in contact with the substrate 124. In such embodiments, the feed wire 122 is retracted away from the substrate 124 once the arc is ignited.

The second voltage can start at different times in the tapping process. In some embodiments, the second voltage is applied while the feed wire 122 is in contact with the substrate 124 and continues to be applied during retraction. In other embodiments, the second voltage is applied only after the feed wire 122 ends contact with the substrate 124 and continues to be applied during retraction. In either case, the second voltage continues to be applied during the tapping process at least until an ignition of the arc is established.

Once the arc is established, the arc can ionize the mixed inner shielding gas 126 and middle shielding gas 128 to form the plasma arc. The distance d2 between the distal end of the tungsten electrode 120 and the feed wire 122 is optimized as discussed above; as can be readily appreciated d2 may vary when different sizes of feed wire and/or different power input (applied voltage and/or current) are used in the torch assembly. As discussed above, although the feed wire 122 is retracted, the plasma arc between the distal end of the tungsten electrode 120 and the substrate 124 remains. Further as above, the plasma arc may have been established in at least two ways: by directly jumping from the distal end of the tungsten electrode 120 to the substrate 124 running along the feed wire 122, or by eventual merger of a first arc between the substrate 124 and the distal end of the feed wire 122 and a second arc between the feed wire 122 and the distal end of the tungsten electrode 120.

Subsequent to the plasma arc ignition, a voltage (or current) can be applied to the MIG torch 102. The power supply can start a MIG arc (not shown) to form between the distal end of the feed wire 122 and the substrate 124. The MIG arc is established within the plasma arc. During the establishment of the MIG arc, the wire feed and application of the voltage (or current) can occur in tandem. After the plasma arc is established and stable, the wire feed can start. Once the feed wire 122 comes down and is able to arc across the gap between the feed wire 122 and the substrate 124, the MIG arc starts. The sequence for starting a dual plasma is complete. Dual plasma deposition can proceed in a steady state with the tungsten electrode 120 power supply and the MIG torch 102 power supply operating. During deposition, the feed wire 122 can be melted by the MIG arc and deposited on the substrate 124 to print a part.

The inner shielding gas 126 flows down the MIG torch 102. In other words, the inner shielding gas 126 flow path is built into the MIG torch 102 and does not interact with the 2-cup nozzle, the middle shielding gas 128 or the outer shielding gas 130 until it exits the MIG torch 102. The inner shielding gas 126 may not be laminar upon exiting the MIG torch 102 and mixing with the middle shielding gas 128 in the cavity near the distal end of the first flow channel 105. After or during the mixing, the inner shielding gas 126 and the middle shielding gas 128 encounter the plasma arc extending from the distal end of the tungsten electrode 120 to the substrate 124, causing the mixed composition to ionize within the plasma arc and flow out from an outlet near the distal end of the third part 109 toward the substrate 124, within the shielding protection of the outer shielding gas 130. The plasma arc surrounds the feed wire 122, cleaning and adding heat to the feed wire above the MIG arc, surrounding the MIG arc, and adding heat to the substrate 124 in a wide path around the MIG arc.

The middle shielding gas 128 can have a laminar flow due to the size, structure, and/or geometry of the first flow channel 105. The injector face at the proximal end of the first flow channel 105 can also contribute to the laminar flow of the middle shielding gas 128. The laminar flow of the middle shielding gas 128 is preferred to maintain the consistency of the plasma arc.

The outer shielding gas 130 functions as a shielding gas. The outer shielding gas 130 maintains an ambient temperature. The outer shielding gas 130 is not ionized during the ignition of the plasma arc or by the MIG arc.

In many embodiments, the dual plasma process can include 4 steps as described above: extending the feed wire, igniting the plasma arc, retracting the feed wire, and igniting the MIG arc. Table 1 lists the arc formation and gas flow during the 4 steps.

TABLE 1
Arc formation and gas flow during the dual plasma process.

| | Extend the | Ignite the plasma | | |
|---|---|---|---|---|
| | wire | arc | Retract the wire | Ignite the MIG arc |
| Arc | No arc. | Plasma arc formed | Plasma arc | Plasma arc |
| formation | | between the | maintained | maintained |
| | | tungsten electrode | between the | between the |
| | | and the substrate. | tungsten | tungsten electrode |
| | | | electrode and | and the substrate. |
| | | | the substrate. | MIG arc formed |
| | | | | between the feed |
| | | | | wire and the |
| | | | | substrate. |
| Gas flow | Flow the | inner and middle | Maintain the | The gas that |
| | inner, | shielding gases are | inner and | shields the MIG arc |
| | middle, | mixed; the mixed | middle shielding | can be ionized for |
| | and outer | gas is ionized by | gases for the | shielding. Flow the |
| | shielding | the plasma arc. | plasma arc. | outer shielding gas |
| | gas. | Flow the outer | Flow the outer | (not ionized) |
| | | shielding gas (not | shielding gas | concurrently. |
| | | ionized) | (not ionized) | |
| | | concurrently. | concurrently. | |

Table 2 lists current profiles during the 4 steps. Current is used as an example for the power supply. Current can also be changed to voltage. No current is applied to the tungsten electrode or the MIG torch during the first step of extending the feed wire. When starting the process of igniting the plasma arc, a current (I_{TIG1}) of small amplitude is applied to the feed wire. The amount of current (I_{TIG1}) is just enough to ignite the plasma arc between the tungsten electrode and the substrate. If the current is too high, the feed wire can be damaged or melt off and the plasma arc ignition may fail. When igniting the MIG arc, the tungsten electrode current can be increased (I_{TIG2}) such that the current amplitude accommodates the desired operational condition of the MIG torch. As can be readily appreciated, I_{TIG1} and/or I_{TIG2} may not be kept constant during their respective steps. I_{TIG1} and/or I_{TIG2} are used to represent the trend of the current and may vary at different time points during the respective steps. The exact amplitude may depend on wire diameter, wire materials, print features (thickness, fineness, etc.).

TABLE 2
Current profile during the dual plasma process.

| | Extend | Ignite | Retract | Ignite MIG | |
|---|---|---|---|---|---|
| | the wire | plasma arc | the wire | arc | Notes |
| Tungsten | No | I_{TIG1} | I_{TIG2} | I_{TIG2} | I_{TIG1} can be |
| electrode | current | | | | greater than, |
| current | | | | | or equal to, or |
| | | | | | less than I_{TIG2}. |
| | | | | | I_{TIG1} is just |
| | | | | | enough to |
| | | | | | establish the |
| | | | | | plasma arc. |
| | | | | | I_{TIG2} is |
| | | | | | adjusted to |
| | | | | | accommodate |
| | | | | | MIG arc |
| | | | | | operation. |
| MIG arc | No | No | No | I_{MIG} | I_{MIG} is |
| current | current | current | current | | adjusted to |
| | | | | | operate the |
| | | | | | MIG arc for |
| | | | | | printing. |

Table 3 lists gas velocity profiles during the 4 steps. When starting the plasma arc, the dual plasma process runs a high velocity of the inner shielding gas (V_{MIG1})I and the outer shielding gas (V_{O}). The high velocity of the shielding gases can keep the feed wire cool during the ignition of the plasma arc. Keeping the feed wire cool during plasma arc ignition can contribute to the consistency and maintenance of the plasma arc. The velocity of the inner shielding gas during the plasma arc ignition step can be at least about 10 ft³/hour; or at least about 15 ft³/hour; or at least about 20 ft³/hour; or at least about 25 ft³/hour; or at least about 30 ft³/hour; or from about 20 ft³/hour to about 30 ft³/hour.

Once the plasma arc is established, the inner shielding gas velocity can be reduced to be in an optimized range for the MIG torch operation. The velocity (V_{MIG2}) can be about one order of magnitude lower than the velocity during the plasma arc ignition. The reduced velocity can be less than about 10 ft³/hour; or less than about 5 ft³/hour; or less than about 3 ft³/hour; or between about 3 ft³/hour to about 5 ft³/hour; or between about 5 ft³/hour and about 10 ft³/hour. As can be readily appreciated, V_{MIG1} and/or V_{MIG2} may not be kept constant during their respective steps. V_{MIG1} and/or V_{MIG2} are used to represent the trend of the gas flow velocity and may vary at different time points during the respective steps. The exact amplitude may depend on wire diameter, wire materials, print features (thickness, fineness, etc.).

During the plasma arc ignition, the inner shielding gas and the middle shielding gas are mixed. The mix ratio of the two gases is optimized for the ignition sequence.

In some embodiments, the velocity of the middle shielding gas can have a similar profile as the inner shielding gas. In some embodiments, the velocity of the middle shielding gas can have a different profile than the inner shielding gas. Although the velocity of the middle shielding gas is listed as V_{TIG} in Table 3, V_{TIG} can be the same or different during each of the four steps of the dual plasma process.

The velocity of each of the inner shielding gas, the middle shielding gas, and the outer shielding gas can be the same or different. In some embodiments, the outer shielding gas can have a higher velocity than the middle shielding gas, and the middle shielding gas can have a higher velocity than the inner shielding gas. Different cross-sectional areas of the channel exits and/or the input flow rate can affect the velocity.

TABLE 3
Gas velocity profile during the dual plasma process.

| Gas velocity | Extend the | Ignite | Retract the | Ignite MIG | |
|---|---|---|---|---|---|
| (ft³/hour) | wire | plasma arc | wire | arc | Notes |
| Inner | V_{MIG1} | V_{MIG1} | V_{MIG2} | V_{MIG2} | V_{MIG1} > V_{MIG2}. |
| shielding | | | | | V_{MIG1} can be |
| gas | | | | | at least 1 |
| | | | | | order of |
| | | | | | magnitude |
| | | | | | higher than |
| | | | | | V_{MIG2}. |
| | | | | | V_{MIG2} is |
| | | | | | adjusted to |
| | | | | | accommodate |
| | | | | | MIG torch |
| | | | | | operation. |
| Middle | V_{TIG} | V_{TIG} | V_{TIG} | V_{TIG} | Middle |
| shielding | | | | | shielding gas |
| gas | | | | | is mixed with |
| | | | | | inner |
| | | | | | shielding gas, |
| | | | | | the mixed gas |
| | | | | | is being |
| | | | | | ionized by the |
| | | | | | plasma arc. |
| Outer | V_{O} | V_{O} | V_{O} | V_{O} | Not ionized |
| shielding | | | | | by plasma arc |
| gas | | | | | or MIG arc. |

Turning now to FIG. 3, to start the dual plasma process, flow (301) shielding gas (such as the inner shielding gas, the middle shielding gas, and the outer shielding gas) in the dual plasma torch assembly. Position (302) the feed wire near the substrate. The feed wire can be positioned near the substrate at an optimal distance d1 as discussed above. The optimal distance d1 enables the ignition of the plasma arc. Apply (303) a second voltage (or current) to the tungsten electrode. A DC power supply can be used to supply the voltage (or current). The current may flow from the tungsten electrode to the substrate or vice versa depending on the polarity of the DC power supply. The tungsten electrode is in close proximity to the feed wire such that an arc can be established from the applied voltage at the tungsten electrode across the feed wire to the substrate. The arc can ionize the shielding gas (such as the mixed inner shielding gas and middle shielding gas) to form (304) the plasma arc. The distance d2 between the distal end of the tungsten electrode and the feed wire is optimized to enable an effective ignition of the plasma arc as discussed above. After the plasma arc is established, retract (305) the feed wire almost instantly. While the feed wire is retracted, the plasma arc between the distal end of the tungsten electrode and the substrate remains. Apply (306) a first voltage (or current) to the feed wire in the MIG torch to establish a MIG arc between the feed wire and the substrate.

Turning now to FIG. 4, the dual plasma starting process can have different steps than the steps in FIG. 3. To start the dual plasma process, flow (401) shielding gas (such as the inner shielding gas, the middle shielding gas, and the outer shielding gas) in the dual plasma torch assembly. Position (402) the feed wire in contact with the substrate. The feed wire can be positioned in contact by extending it from the MIG torch until a continuity tester reports an electrically conductive pathway has been achieved; in other words, the feed wire can be tapped on the substrate. The continuity tester can be part of the first power supply for the MIG torch. In such embodiments, the feed wire is initially nearer to the substrate than the distance d1.

The feed wire that is in contact with the substrate can be retracted (403) back into the MIG torch. A second voltage (or current) can be applied (404) to the tungsten electrode by the second power supply. The second voltage (or current) can be applied during the tapping process when the feed wire is in contact with the substrate, or after the feed wire retraction starts. In other words, steps 403 and 404 can be performed as depicted in FIG. 4, or in the opposite order.

Determine (405) if a plasma arc is ignited or not. The applied voltage may or may not create an arc between the distal end of the tungsten electrode and the substrate using the conductive path of the feed wire. In other words, the tungsten electrode is in close proximity to the feed wire such that an arc can be established from the tungsten electrode to the substrate, although this establishment may not succeed during a first attempt. In some embodiments, the second power supply for the tungsten electrode can self-determine that it is not consuming enough power to support an ignited plasma arc. If the ignition of the plasma arc is not successful, the dual plasma process can restart by repositioning the feed wire in contact with the substrate, repeating the tapping process, and re-attempting to ignite the plasma arc by repeating steps 402 through 405. Restarts can occur indefinitely until ignition is successful. If the ignition of the plasma arc is successful, the arc can ionize the mixed inner shielding gas and middle shielding gas to form the plasma arc. As discussed above, although the feed wire is retracted, the plasma arc between the distal end of the tungsten electrode and the substrate remains. Apply (406) a first voltage (or current) to the feed wire in the MIG torch to establish a MIG arc between the feed wire and the substrate.

### Comparison Between Dual Plasma Processes

A previously disclosed dual plasma process (See, e.g., U.S. Patent Publication 20240253146 A1 to F. Gruber, et al., which is incorporated in this disclosure by reference) uses a pilot power supply to start a pilot arc between the tungsten electrode and an inner wall of the dual plasma nozzle. The previously reported dual plasma nozzle has three power supplies: a pilot power supply, a power supply for the tungsten electrode, and a power supply for the MIG torch. At the beginning of the previously disclosed dual plasma process, all three power supplies are turned off, and the feed wire in the MIG torch is retracted. First, the high-voltage, high-frequency plasma pilot power supply is turned on, which causes a pilot arc to form between the tungsten electrode and an inner wall of the dual plasma nozzle. Second, the tungsten electrode power supply is turned on, which uses the ionized path created from the pilot arc to establish an arc between the tungsten electrode and the substrate, becoming an extended TIG arc. Third, the pilot power supply is turned off, because the tungsten electrode power supply can sustain the extended TIG arc between the tungsten electrode and the substrate. Fourth, the feed wire in the MIG torch is extended towards the substrate. Fifth, the MIG power supply is turned on, causing a short MIG arc to form between the distal end of the feed wire and the substrate. At this point, the sequence is complete and dual plasma deposition proceeds in a steady state with only the tungsten electrode power supply and the MIG power supply operating.

In contrast, the dual plasma process in accordance with many embodiments of the present disclosure does not use a pilot power supply. The dual plasma process in accordance with many embodiments extends the feed wire 122 sooner to bridge the plasma arc between the distal end of the tungsten electrode 120 and the substrate 124. The dual plasma torch assembly 101 in accordance with several embodiments is smaller in size compared to the previously reported dual plasma nozzle. The distance between the tungsten electrode and the feed wire (such as d2) of the dual plasma torch assembly 101 in accordance with several embodiments is smaller than the distance of the previously reported dual plasma nozzle. In some embodiments, the dual plasma torch assembly 101 has only one tungsten electrode 120. In some embodiments, the dual plasma torch assembly 101 can have more than one tungsten electrode, such as two tungsten electrodes, or three tungsten electrodes. As can readily be appreciated, any of a variety of the number of tungsten electrodes can be utilized as appropriate to the requirements of specific applications in accordance with various embodiments of the invention. In some embodiments, the dual plasma torch assembly can have a smaller number of tungsten electrodes compared to the previously disclosed dual plasma nozzles. The reduction of tungsten electrodes can yield improved control on the plasma arc. As the plasma arc establishes between the tungsten electrode(s) and the substrate, the reduced number of tungsten electrodes have reduced number of pathways where the plasma arc can be ignited.

### Dual Plasma Multi-Wire Wire Arc Additive Manufacturing

3D metal printers have been produced for printing large 3D structures. An example implementation uses WAAM. Other example implementations of “additive layer manufacturing” using large 3D metal printers are described in U.S. Patent Publication 20240017340 A1 to K. Konrath, et al., which is incorporated in this disclosure by reference. The applicant has demonstrated that such large 3D metal printers can print structures 2.75 m (9 ft) or more in diameter and 4.5 m (15 ft) or more in length. With such large 3D metal printers, the printing process involves moving a weld pool along a path while feeding material into the weld pool. The print envelope of such large 3D metal printers greatly exceeds the print envelope of other printing processes such as direct metal laser sintering (DMLS), also called laser powder bed fusion (LPBF), which are 3D metal printers that typically have a print envelope less than or equal to 600 mm diameter by 950 mm in length. With such large 3D metal printers, it is desirable to print the structures quickly such that more structures can be printed within a time period, thereby improving the return on investment on building the printers, printing facilities, etc. A structure may include a known amount of material. The material may include various materials such as aluminum (e.g. aluminum alloys) or nickel (e.g. Inconel). Example compositions of the materials are described in U.S. Patent Publication 20230313345 A1 to S. J. Tonneslan, et al., and U.S. Patent Publication 20240026497 A1 to S. J. Tonneslan, et al., which are incorporated in this disclosure by reference.

Various embodiments of the disclosure include additional feed wires, which can be used to deposit additional material into the weld pool. In these instances, the total deposition rate is the rate at which material is deposited using all of the feed wires. In several embodiments, one or more additional feed wires can be used. In this regard, at least a second feed wire can be fed into the weld pool. The second feed wire may be utilized as a “cold” wire. As used herein, a cold wire refers to a feed wire that does not carry electrical energy into the weld pool or carries less electrical energy than the “hot” wire, which is the electrode wire or feed wire carrying electrical energy into the weld pool. A cold wire can be pre-heated, e.g., using a charge, before it is deposited and still meets the definition of cold wire. In this regard, use of a current with a cold wire can preheat the wire and allow for easier melt-off; yet, although the current suffices to provide heat, the current does not result in an arc. Use of a cold wire in conjunction with a hot wire increases the mass of metal deposited into the weld pool. Cold wires are described in U.S. Patent Publication 20230173601 A1 to F. Gruber, et al., and U.S. Patent Publication 20240058881 A1 to F. Gruber, et al., which are incorporated in this disclosure by reference. Having no charge (no preheating) may be beneficial for the wires described in the incorporated applications. Preheating may have benefits for other wires, such as Inconel or steel.

In some embodiments, the electrical energy carried by the hot wire or electrode wire (described above) is sufficient to melt the cold wire (the second feed wire) without providing electrical energy to the cold wire. In some embodiments, the second feed wire can be compositionally and structurally identical to the electrode wire. In some embodiments, the second feed wire may be compositionally and/or structurally different from the electrode wire. For example, the second feed wire can be of a different material than the electrode wire and/or have a different diameter than the electrode wire. In some embodiments, the second feed wire can be fed into the weld pool at the same rate as the electrode wire, which results in double the printing rate and thus the printing time may be cut in half. Other rates are within the scope of the invention, however, and the rate at which the second wire can be fed into the weld pool is a parameter that can be determined based on a mathematical model of the two-wire deposition process and the other process parameters. Using the mathematical model saves considerable development time because otherwise a great deal of experimentation may be carried out to map out the second wire feed rate as a function of the other process parameters such as input electric power and the electrode feed rate. Even more experimentation may be beneficial when different wires with different burn-off characteristics are used.

In 3D printing, a toolpath file can be used to specify the actions that printing components are to take, the order in which the actions are to be taken, and when each action is to be taken. For example, a first action can be to move the print head along a specified path at a specified travel speed. At the same time, wire feeders can feed wires at specified rates and the electrode current, and voltage produced by an electric power source can be set. Another action can be taken when the print head completes its movement along the first path such that the print head moves along a different specified path at the same or a different specified travel speed. Changes in the feed rates and input electric power can be set to occur at various locations along the specified travel paths. Those familiar with 3D printing are familiar with the creation of and contents of toolpath files. Common toolpath file formats include GCODE, X3G, etc.

Combining multi-wire (e.g., a hot wire and one or more cold wires, as the term is defined above) feeding processes with dual plasma WAAM processes can beneficially improve WAAM deposition rates. In accordance with many embodiments, one or more cold wires can be advanced into a weld pool generated by a dual plasma WAAM process. The cold wires can be in addition to the electrode wire (e.g., hot wire). In several embodiments, cold wires can be run at a feed rate less than the feed rate used for the hot wire in dual-plasma multi-wire process. For example, cold wires can be run at about 50% feed rate compared to feed rate of a hot wire. In some embodiments, cold wires can be run at less than about 50% feed rate compared to feed rate of a hot wire. In certain embodiments, cold wires can be run at greater than about 50% feed rate compared to feed rate of a hot wire. Dual plasma multi-wire processes can, in accordance with embodiments, achieve deposition rates of around 25 pounds per hour. In several embodiments, dual plasma multi-wire processes can achieve deposition rates of greater than about 25 pounds per hour. This deposition rate can be achieved with aluminum alloy wires in accordance with embodiments of the invention. In several embodiments, deposition rates can increase with the inclusion of additional cold wires. For example, in many embodiments, advancing 3 cold wires into a weld pool during a WAAM process can permit achievement of a deposition rate of at least around 30 pounds per hour. For comparison, various legacy systems can have deposition rates of around 3.9 pounds per hour to around 6.3 pounds per hour. This solution improves the deposition rate without significant degradation of defect levels.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the,” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. Where ranges are described, the range should be understood to include the endpoints of the ranges, and the endpoints of such ranges are also contemplated to stand on their own as inventive, individual data points and to form the endpoints of other ranges. For example, a ratio in the range of about 1 to about 200 should be understood to include the explicitly recited limits of about 1 and about 200, but also to include individual ratios such as about 2, about 3, and about 4, sub-ranges such as about 1 to about 10, about 10 to about 50, about 20 to about 100, about 100 to about 200, and so forth, and related ranges such as greater than about 1 or less than about 200.

1.-20. (canceled)

21. A method comprising:
emitting an outer shielding gas from a torch assembly toward a substrate;
emitting an ionizing gas from the torch assembly toward the substrate, wherein the ionizing gas is substantially surrounded by the outer shielding gas;
extending a consumable electrode wire from the torch assembly toward the substrate, wherein the consumable electrode wire is substantially surrounded by the ionizing gas and the outer shielding gas;
retracting the consumable electrode wire away from the substrate;
attempting to establish a second electrical current between a nonconsumable electrode and the substrate, wherein a successful establishment at least partially ionizes the ionizing gas into a plasma;
if the attempting is not successful, then repeating the extending, retracting, and attempting until the attempting is successful; and
if the attempting is successful, then establishing a first electrical current between the consumable electrode wire and the substrate, wherein the first electrical current melts an end of the consumable electrode wire for deposition upon the substrate while the consumable electrode wire is substantially surrounded by the plasma and the outer shielding gas.

22. The method of claim 21, wherein the ionizing gas comprises an inner shielding gas and a middle shielding gas.

23. The method of claim 22, further comprising mixing the inner shielding gas and the middle shielding gas in a mixing region within the torch assembly to create the ionizing gas.

24. The method of claim 21, further comprising determining that the end of the consumable electrode wire is in contact with the substrate, after extending the consumable electrode wire and before retracting the consumable electrode wire.

25. The method of claim 24, wherein the determining that the end of the consumable electrode wire is in contact with the substrate is based on an electrical continuity test.

26. A method comprising:
feeding a feed wire through a main channel of a torch assembly, wherein a distal end of the feed wire is in proximity to a substrate;
supplying an inner shielding gas along the feed wire;
supplying a middle shielding gas, wherein the inner shielding gas mixes with the middle shielding gas near a distal end of the main channel;
applying a second electrical current through an electrode disposed at the distal end of the main channel to the distal end of the feed wire such that the second electrical current is configured to start an arc that is configured to ionize a mixture of the inner and middle shielding gases to form a plasma arc surrounding the feed wire;
retracting the feed wire away from the distal end of the main channel; and
applying a first electrical current through the feed wire, wherein the first electrical current is configured to create an electric arc to melt the feed wire to be deposited onto the substrate.

27. The method of claim 26, wherein the electrode is positioned inside the torch assembly.

28. The method of claim 26, wherein the electric arc is configured to ionize the inner shielding gas to form a shielding gas arc, wherein the shielding gas arc is positioned within the plasma arc.

29. The method of claim 28, wherein the plasma arc and the shielding gas arc surround a molten feed wire annually when the molten feed wire is deposited onto the substrate.

30. The method of claim 26, further comprising reducing a velocity of supplying the inner shielding gas along the feed wire when applying the second electrical current through the feed wire.

31. The method of claim 26, further comprising applying a third electrical current through the electrode when retracting the feed wire, wherein the third electrical current is greater than the first electrical current.

32. The method of claim 26, further comprising supplying an outer shielding gas surrounding the feed wire, wherein the outer shielding gas is not ionized.

33. The method of claim 26, further comprising maintaining the plasma arc while retracting the feed wire.

34. The method of claim 26, wherein the middle shielding gas has a laminar flow profile.

35. A method comprising:
supplying an inner shielding gas along a feed wire, wherein the feed wire is fed through a main channel of a torch assembly;
supplying a middle shielding gas, wherein the inner shielding gas mixes with the middle shielding gas near a distal end of the main channel;
positioning a distal end of the feed wire in contact with a substrate;
retracting the feed wire away from the substrate;
applying a second electrical current through an electrode disposed at the distal end of the main channel to the distal end of the feed wire, wherein the second electrical current is configured to ignite an arc;
determining if the arc is ignited:
if not ignited, repeating the positioning, retracting, applying the second electrical current, and determining steps until the arc is ignited; wherein the arc is configured to ionize a mixture of the inner and middle shielding gases to form a plasma arc surrounding the feed wire; and
applying a first electrical current through the feed wire, wherein the first electrical current is configured to create an electric arc to melt the feed wire to be deposited onto the substrate.

36. The method of claim 35, wherein the electrode is positioned inside the torch assembly.

37. The method of claim 35, wherein the electric arc is configured to ionize the inner shielding gas to form a shielding gas arc, wherein the shielding gas arc is positioned within the plasma arc.

38. The method of claim 35, further comprising applying a third electrical current through the electrode when retracting the feed wire, wherein the third electrical current is greater than the first electrical current.

39. The method of claim 35, further comprising supplying an outer shielding gas surrounding the feed wire, wherein the outer shielding gas is not ionized.

40. The method of claim 35, further comprising maintaining the plasma arc while retracting the feed wire.
